(19) United States
(12) Patent Application Publication
(10) Pub. No.: US 2019/0017728 A1
(43) Pub. Date: Jan. 17, 2019

(54) Heat Receiver Tube With Metallic Sealing

(71) Applicant: SIEMENS CONCENTRATED SOLAR POWER LTD., Rosh Ha'ayin (IL)

(72) Inventor: Shmulik KLAPWALD, Jerusalem (IL)

(73) Assignee: Siemens Concentrated Solar Power Ltd., Rosh Ha'ayin (IL)

(21) Appl. No.: 16/068,525

(22) PCT Filed: Dec. 7, 2016
(86) PCT No.: PCT/EP2016/079996

§ 371 Date: Jul. 6, 2018

(30) Foreign Application Priority Data
Jan. 8, 2016 (EP) 16150577.1

(51) Int. Cl. F24S 10/40; F24S 23/71; B23K 26/00; B23K 26/282

(52) U.S. Cl. CPC F24S 10/45; F24S 23/71; F24S 2025/6013; B23K 26/282; B23K 26/0006

(57) ABSTRACT

A heat receiver tube for absorbing solar energy and for transferring absorbed solar energy to a heat transfer fluid may include: a core tube with a solar energy absorptive coating for absorbing solar radiation, the heat transfer fluid at least partially inside the core tube; and an enveloping tube surrounding the core tube, the enveloping tube including an inner enveloping tube surface. The core tube and the enveloping tube are coaxially arranged forming an inner heat receiver tube space. There is an inert gas in the inner heat receiver tube space. The tube may further include a dimension adapting device having a flexible adapting device wall compensating for thermally induced changes in a dimension of the tube. The enveloping tube and the dimension adapting device are joined together by a skirt having an inlet port for the inert gas. The inlet port is sealed with a metal.

### CROSS-REFERENCE TO RELATED APPLICATIONS

This application is a U.S. National Stage Application of International Application No. PCT/EP2016/079996 filed Dec. 7, 2016, which designates the United States of America, and claims priority to EP Application No. 16150577.1 filed Jan. 8, 2016, the contents of which are hereby incorporated by reference in their entirety.

### TECHNICAL FIELD

The present disclosure relates to solar collectors. Various embodiments may include a heat receiver tube, a method for manufacturing the heat receiver tube, a solar collector with the heat receiver tube, and/or a method for producing electricity by using of the solar collector.

### BACKGROUND

A sun energy collecting unit (solar collector) of a sun field power plant based on the concentrated solar power technique may include a solar collector with a parabolic mirror and a heat receiver tube. The heat receiver tube is arranged in a focal line of a solar radiation (sunlight) reflecting surface of the mirror. By the solar radiation reflecting surface sunlight is collected and focused to the heat receiver tube.

The heat receiver tube comprises a core tube (inner tube, e.g. made of stainless steel) which is filled with a heat transfer fluid, e.g. a thermo-oil or molten salt. With the aid of a solar radiation absorptive coating of the core tube the heat receiver tube absorbs energy from the sun. Energy from the sun is efficiently coupled into the heat transfer fluid. Solar energy is converted into thermal energy.

In order to minimize a loss of thermal energy, the heat receiver tube comprises an encapsulation with an enveloping tube. The enveloping tube envelops the core tube. For instance, the enveloping tube is a glass tube. This enveloping tube is at least partly transparent for solar radiation. So, solar radiation can impinge the solar radiation absorptive coating of the core tube. The core tube and the enveloping tube are coaxially arranged to each other resulting in an inner space of the heat receiver tube which is bordered by a core tube surface of the core tube and by an inner enveloping tube surface of an enveloping tube wall of the enveloping tube.

The inner space of the heat receiver tube between the inner tube and the enveloping tube is evacuated in order to minimize convection and hence in order to minimize a thermal loss of the heat receiver tube. The inner heat receiver tube space is a vacuum chamber.

One problem is a degradation of the heat transfer fluid during operation for years. By the degradation Hydrogen (H₂) results. This Hydrogen permeates through the stainless steel wall of the core tube into the evacuated inner space of the heat transfer tube. The result is a collapse of the vacuum of the inners space of the heat receiver tube and hence an increase of the thermal loss of the heat receiver tube. One way to completely solve the described problem of installed hot heat receiver tubes is to replace them by new ones. But this solution is cost-intensive.

### SUMMARY

Various embodiments of the teaching herein may provide low thermal loss during the operation of a heat receiver tube. For example, some embodiments may include a heat receiver tube (1) for absorbing solar energy and for transferring absorbed solar energy to a heat transfer fluid (111) which can be located inside of at least one core tube (11) of the heat receiver tube (1). The core tube (11) comprises a core tube surface (112) with at least one solar energy absorptive coating (1121) for absorbing solar radiation (2). The core tube (11) is enveloped by at least one enveloping tube (10). The enveloping tube (10) comprises at least one enveloping tube wall (101) which is at least partly transparent for the solar radiation (2). The enveloping tube wall (101) comprises at least one inner enveloping tube surface (102). The core tube (11) and the enveloping tube (10) are coaxially arranged to each other such that an inner heat receiver tube space (3) is formed which is bordered by the core tube surface (112) and the inner enveloping tube surface (102). The inner heat receiver tube space (3) comprises an inert gas (5). The heat receiver tube (1) comprises at least one dimension adapting device (6) with a flexible adapting device wall (60) for compensation of a thermally induced change of at least one dimension of the heat receiver tube (1). The enveloping tube (10) and the dimension adapting device (6) are joined together by at least one heat receiver tube skirt (103) with at least one heat receiver tube skirt wall (1031). The heat receiver tube skirt wall (1031) comprises at least one inlet port (4) for pouring in of at least one inert gas (5) into the inner heat receiver tube space (3). The inlet port (4) is sealed by an inlet port sealing (40) for inhibiting a leakage of the inert gas (5) out of the inner heat receiver tube space (4) and the inlet port sealing (4) comprises at least one metal (41).

In some embodiments, the inlet port sealing (40) comprises a welding (42).

In some embodiments, the inlet port (4) comprises an inlet port dimension (401) which may be selected from the range between 0.02 mm and 1.5 mm and may be selected from the range between 0.2 mm and 0.5 mm.

In some embodiments, the inert gas (5) is at least one noble gas (50) which selected from the group consisting of Krypton and Xenon. In some embodiments, a partial pressure of the inert gas (5) in the inner heat receiver tube space (3) is selected from the range between 5 mbar and 300 mbar or between 100 mbar and 200 mbar.

In some embodiments, the dimension adapting device (6) comprises bellows (61) and the flexible adapting device wall (60) comprises a bellows wall (611).

In some embodiments, the bellows (61) are arranged at a front side (13) of the heat receiver tube (1).

As another example, a method for manufacturing a heat receiver tube may include:
a) Providing of at least one precursor tube of the heat receiver tube (1);
b) Arranging of at least one inlet port (4) in heat receiver tube skirt wall (1031);
c) Pouring in of at least one inert gas (5) into the inner heat receiver tube space (3) of the heat receiver tube (1); and
d) Sealing of the inlet port (4) with the aid of a sealing (40).

In some embodiments, the arranging of the inlet port (4) comprises a drilling of a hole into heat receiver tube skirt wall (1031).

In some embodiments, the sealing of the inlet port (4) comprises a welding.

In some embodiments, for the drilling and/or for the welding at least one laser is used. In some embodiments, for the drilling and for the welding the same laser is used.

In some embodiments, as precursor heat receiver tube a receiver tube is used, which is installed in a solar field (1001) of a solar thermal power plant.

As another example, some embodiments may include a solar collector (1000) comprising:
at least one mirror (7) having a solar radiation (2) reflecting mirror surface (70) for directing the solar radiation (2) to a focal line (71) of the solar radiation reflecting mirror surface (70); and
at least one heat receiver tube (1) according to one of the claims 1 to 7 which is arranged in the focal line (71) of the solar radiation reflecting mirror surface (70).

In some embodiments, the mirror (7) is a parabolic mirror or a Fresnel mirror.

As another example, some embodiments may include a method for producing electricity by using the solar collector (1000) described above in a solar thermal power plant for converting solar radiation (2) into electrical energy, wherein an absorbing of the solar radiation (2) is carried out with the aid of the solar collector (1000).

### BRIEF DESCRIPTION OF THE DRAWINGS

Further features of the teachings herein are highlighted from the description of an exemplary embodiment with reference to the drawings. The drawings are schematic.

FIG. 1 shows cross sections of a heat receiver tube according to teachings of the present disclosure;

FIG. 2 shows a cross section perpendicular to FIG. 1.

FIG. 3 shows a part of the heat receiver tube of FIG. 1.

FIG. 4 shows a cross section of a parabolic through collector with the heat receiver tube according to teachings of the present disclosure.

### DETAILED DESCRIPTION

In some embodiments, a heat receiver tube for absorbing solar energy and for transferring absorbed solar energy to a heat transfer fluid can be located inside of at least one core tube of the heat receiver tube. The core tube comprises a core tube surface with at least one solar energy absorptive coating for absorbing solar radiation. The core tube is enveloped by at least one enveloping tube. The enveloping tube comprises at least one enveloping tube wall which is at least partly transparent for the solar radiation. The enveloping tube wall comprises at least one inner enveloping tube surface. The core tube and the enveloping tube are coaxially arranged to each other such that an inner heat receiver tube space is formed which is bordered by the core tube surface and the inner enveloping tube surface. The inner heat receiver tube space comprises an inert gas. The heat receiver tube comprises at least one dimension adapting device with a flexible adapting device wall for compensation of a thermally induced change of at least one dimension of the heat receiver tube. The enveloping tube and the dimension adapting device are joined together by at least one heat receiver tube skirt with at least one heat receiver tube skirt wall.

In some embodiments, the enveloping tube and the dimension adapting device are just covered by the heat receiver tube skirt. The heat receiver tube skirt wall comprises at least one inlet port for pouring in of at least one inert gas into the inner heat receiver tube space. The inlet port is sealed by an inlet port sealing for inhibiting a leakage of the inert gas out of the inner heat receiver tube space. The inlet port sealing comprises at least one metal.

In some embodiments, a method for manufacturing a heat receiver tube includes: a) providing of at least one precursor tube of the heat receiver tube, b) arranging of at least one inlet port in heat receiver tube skirt wall, c) pouring in of at least one inert gas into the inner heat receiver tube space of the heat receiver tube and d) sealing of the inlet port with the aid of a sealing.

In some embodiments, a solar collector comprises at least one mirror having a solar radiation reflecting mirror surface for directing the solar radiation to a focal line of the solar radiation reflecting mirror surface and at least one heat receiver tube which is arranged in the focal line of the solar radiation reflecting mirror surface. In some embodiments, the mirror is a parabolic mirror or a Fresnel mirror. The mirror is a parabolic mirror with a parabolic shaped solar radiation reflecting mirror surface. In some embodiments, the mirror is a Fresnel mirror. Thereby it is not necessary that the heat receiver tube is exactly located in the focal line of the mirror. Aberrations from an exact arrangement in the focal line are possible, too.

In some embodiments, there is a method for producing electricity by using the solar collector in a solar thermal power plant for converting solar radiation into electrical energy, wherein an absorbing of the solar radiation is carried out with the aid of the solar collector.

In some embodiments, the inert gas is at least one noble gas which selected from the group consisting of Krypton and Xenon. Other gases or mixtures of different gasses are possible, too. In order to keep the inert gas in the inner heat receiver space the inlet port is sealed with the aid of a sealing. So, after the pouring of the inert gas though the inlet port a sealing of the inlet port is carried out. With the aid of the sealing the loss of inert gas is avoided.

In some embodiments, the inlet port sealing is a metallic inlet port sealing. This metallic inlet port sealing consists of a pure metal or consists of an alloy of various metals. In some embodiments, the inlet port sealing comprises a welding. The inlet port is sealed by a welding.

In some embodiments, the heat receiver tube skirt is a metal joint or a metal adapter between the enveloping tube and the dimension adapting device. The inlet port is arranged in the heat receiver tube skirt wall.

In some embodiments, the dimension adapting device comprises bellows and the flexible adapting device wall comprises a bellows wall. The bellows may be arranged at a front side of the heat receiver tube.

In some embodiments, the inlet port comprises an inlet port dimension which is selected from the range between 0.02 mm and 1.5 mm and preferably selected from the range between 0.2 mm and 0.5 mm.

For instance, the inner core tube comprises a core tube wall which is made of stainless steel. The enveloping tube which is transparent for the sunlight (transmission for specific wavelengths more the 90%) is arranged coaxially around the inner core tube of the heat receiver tube. The enveloping tube is preferably made of glass. The enveloping tube wall comprises glass. But other transparent materials are possible, too.

The core tube surface and the inner enveloping tube surface may be oppositely arranged to each other. The result is a chamber which is filled with the inert gas.

In some embodiments, a partial pressure of the inert gas in the inner heat receiver tube space is selected from the range between 5 mbar and 300 mbar and may be between 100 mbar and 200 mbar. For instance, the inner space of the heat receiver tube is filled with Xe with a partial pressure of about 150 mbar. To achieve these partial pressures of the inert gas it is not necessary to evacuate the inner heat receiver tube space. An evacuation of the inner heat receiver tube space can be skipped.

In some embodiments, a method for manufacturing of the heat receiver tube, the arranging of the inlet port comprises a drilling of a hole into heat receiver tube skirt wall. In some embodiments, the sealing of the inlet port comprises a welding. The inlet port is sealed by a welding.

In some embodiments, for the drilling and/or for the welding at least one laser is used. The drilling of the hole comprises a laser drilling. The welding is carried out by laser welding. In some embodiments, for the drilling and for the welding the same laser is used. So, it is not necessary to exchange the necessary laser equipment. Just settings of the laser for the specific applications (drilling of welding) have to be adapted.

In some embodiments, as a precursor heat receiver tube a receiver tube is used, which is installed in a solar field of a solar thermal power plant. Base on the invention the result a heat receiver tube with acceptable thermal features. It is not necessary to replace a hear receiver tube which is installed in a solar field of a solar thermal power plant.

In some embodiments, the solar collector is employed in a solar thermal power plant for converting solar energy into electrical energy. Thereby an absorbing of the sunlight energy is carried out with the aid of the solar collector. Solar radiation is converted into thermal energy of a heat transfer fluid which is located in the core tube. The heat transfer fluid is a thermo-oil or a molten salt. Via a heat exchanger thermal energy of the heat transfer fluid is used to produce steam. This steam drives a turbine which is connected to a generator. The generator produces current.

In some embodiments, it is possible to maintain proper thermal characteristics of the heat receiver tube. It is not necessary to exchange the heat receiver tube after a couple of years of operation.

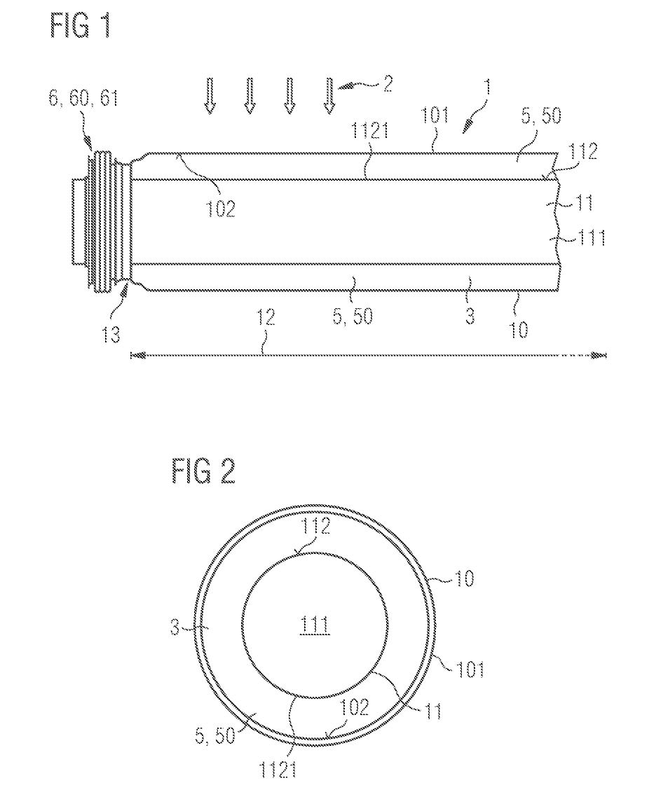

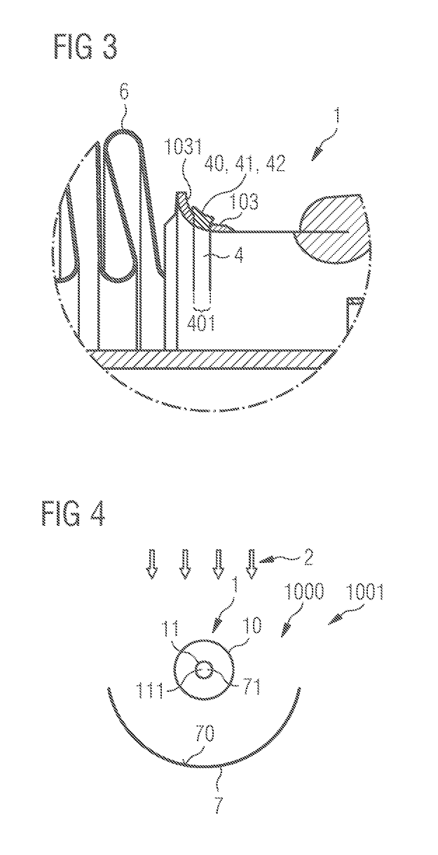

FIG. 1 shows an example heat receiver tube 1. The heat receiver tube 1 comprises a core tube 11 stainless steel. The core tube 11 comprises a core tube surface 112 with at least one solar energy absorptive coating for absorbing solar radiation 2 of the sunlight In the core tube 11 a heat transfer fluid 111 can be located. The heat transfer fluid 111 is a thermo-oil. In some embodiments, the heat transfer fluid 111 is molten salt.

The enveloping tube 10 comprises an enveloping tube wall 101 out of glass. This enveloping tube wall is transparent for the solar radiation 2. The enveloping tube wall 101 comprises an inner enveloping tube surface 102, the external surface is coated by an AR layer (anti reflecting coating).

The core tube 11 and the enveloping tube 10 are coaxially arranged to each other. The core tube surface 112 and the inner enveloping tube surface 102 arranged face to face. By this an inner heat receiver tube space 3 results which is bordered by the core tube surface 112 and the inner enveloping tube surface 102.

The core tube 11 and the enveloping tube 10 are coaxially arranged to each other such that an inner heat receiver tube space 3 is formed which is bordered by the core tube surface 112 and the inner enveloping tube surface 102. At a front side 13 of the heat receiver tube 1 a dimension adapting device 6 with a flexible adapting device wall 60 for compensation of a thermally induced change of at least one dimension 12 of the heat receiver tube 1 may be arranged. The dimension adapting device 6 may comprise bellows 61 with a bellow walls 611.

In some embodiments, the enveloping tube 10 and the dimension adapting device 6 are joined together by at least one heat receiver tube skirt 103 with at least one heat receiver tube skirt wall 1013. The heat receiver tube skirt wall 1031 may comprise at least one inlet port 4 for pouring in of at least one inert gas 5 into the inner heat receiver tube space 3.

For the arranging of the inlet port into the heat receiver tube skirt wall a laser drilling of a hole into the heat receiver tube skirt may be carried out. The inlet port 4 is sealed by an inlet port sealing 40 for inhibiting a leakage of the inert gas 5 out of the inner heat receiver tube space 3. The inlet port sealing 4 is a welding. For the welding 4 a laser welding is carried out. The laser welding is carried out with the same laser which is used of the laser drilling. Alternatively, different lasers are used of the laser drilling and for the laser welding.

The inlet port dimension 401 of the inlet port 4 may be in the range of 0.02 mm-1.5 mm. In some embodiments, the inert gas 5 is Xenon. In some embodiments, the inert gas 5 is Krypton. A partial pressure of the inert gas may be about 150 mbar.

In some embodiments, the heat receiver tube 1 is part of a solar collector 1000. The solar collector 1000 comprises at least one parabolic mirror 7 with a sunlight reflective surface 31. By the solar radiation reflecting surface 70 the sunlight 2 is directed to the focal line 71 of the parabolic mirror 7. The concentrated sunlight is absorbed by the heat receiver tube 1 (FIG. 4). The heat receiver tube 1 may be arranged on the side of the incoming direct sunlight radiation 2.

In some embodiments, the solar collector 1000 is used for a solar field 1001 of a solar thermal power plant for converting solar energy into electrical energy. The heated heat transfer fluid is used to produce steam via a heat exchanger. The steam is driving a turbine, which is connected to a generator. The generator produces current (electrical energy).

What is claimed is:

1. A heat receiver tube for absorbing solar energy and for transferring absorbed solar energy to a heat transfer fluid, the heat receiver tube comprising:
a core tube
comprising a core tube surface with a solar energy absorptive coating for absorbing solar radiation, the heat transfer fluid at least partially inside the core tube;
an enveloping tube surrounding the core tube,
the enveloping tube including an enveloping tube wall at least partly transparent for the solar radiation, wherein
the enveloping tube wall comprises an inner enveloping tube surface;
wherein the core tube and the enveloping tube are coaxially arranged such that an inner heat receiver tube space is bordered by the core tube surface and the inner enveloping tube surface;
an inert gas in the inner heat receiver tube space; and
a dimension adapting device having a flexible adapting device wall compensating for thermally induced change a dimension of the heat receiver tube;
wherein the enveloping tube and the dimension adapting device are joined together by a skirt with a skirt wall having an
inlet port for introducing the inert gas into the inner heat receiver tube space;
wherein the inlet port is sealed by an inlet port sealing
with a metal.

2. A heat receiver tube according to claim 1, wherein the inlet port sealing comprises a weld.

3. A heat receiver tube according to claim 1, wherein the inlet port has an opening in the range between 0.02 mm and 1.5 mm.

4. A heat receiver according to claim 1, wherein the inert gas comprises a noble gas.

5. A heat receiver tube according to claim 1, wherein a partial pressure of the inert gas in the inner heat receiver tube space is between 5 mbar and 300 mbar.

6. A heat receiver tube according to claim 1, wherein:
the dimension adapting device comprises bellows; and
the flexible adapting device wall comprises a bellows wall.

7. A heat receiver tube according to claim 6, wherein the bellows are arranged at a front side of the heat receiver tube.

8. A method for manufacturing a heat receiver tube, the method comprising:
arranging a core tube and an enveloping tube coaxially such that an inner heat receiver tube space is bordered by the core tube surface and the inner enveloping tube surface;
arranging an inlet port in a heat receiver tube skirt wall;
adding an inert gas into the inner heat receiver tube; and
sealing the inlet port.

9. A method according to claim 8, wherein arranging the inlet port comprises drilling a hole into the heat receiver tube skirt wall.

10. A method according to claim 8, wherein sealing the inlet port comprises welding.

11. A method according to claim 9, wherein drilling and/or welding includes using a laser.

12. A method according to claim 11, wherein a single laser is used for drilling and for welding.

13. A method according to claim 8, further comprising installing a receiver tube in a solar field of a solar thermal power plant.

14. A solar collector comprising:
a mirror with a solar radiation reflecting surface directing solar radiation to a focal line of the solar radiation reflecting surface; and
a heat receiver tube arranged in the focal line of the solar radiation reflecting mirror surface, the heat receiver tube comprising:
a core tube comprising a core tube surface with a solar energy absorptive coating for absorbing solar radiation, the heat transfer fluid at least partially inside the core tube;
an enveloping tube surrounding the core tube, the enveloping tube including an enveloping tube wall at least partly transparent for the solar radiation, wherein the enveloping tube wall comprises an inner enveloping tube surface;
wherein the core tube and the enveloping tube are coaxially arranged such that an inner heat receiver tube space is bordered by the core tube surface and the inner enveloping tube surface;
an inert gas in the inner heat receiver tube space; and
a dimension adapting device having a flexible adapting device wall compensating for thermally induced change a dimension of the heat receiver tube;
wherein the enveloping tube and the dimension adapting device are joined together by a skirt with a skirt wall having an inlet port for introducing the inert gas into the inner heat receiver tube space;
wherein the inlet port is sealed by an inlet port sealing with a metal.

15. A solar collector according to claim 14, wherein the mirror comprises a parabolic mirror or a Fresnel mirror.

16. (canceled)
